(19) United States
(12) Patent Application Publication
(10) Pub. No.: US 2009/0050762 A1
(43) Pub. Date: Feb. 26, 2009

(54) Device Mount

(76) Inventors: Venkat R. Mallela, Tucson, AZ (US); Gerald Edward Peterson, Riverside, CA (US); Raleigh C. Ormerod, IV, Sahuarita, AZ (US); Shuvendu Kumar Mishra, Bangalore (IN)

Correspondence Address: FITCH EVEN TABIN AND FLANNERY, 120 SOUTH LA SALLE STREET, SUITE 1600, CHICAGO, IL, 60603-3406, US

(21) Appl. No.: 11/844,760

(22) Filed: Aug. 24, 2007

(51) Int. Cl. F16M 11/04

(52) U.S. Cl. 248/278.1; 248/310

(57) ABSTRACT

A device mount to support a device has a base and an arm supported by the base. The arm engages the base with a polyaxial engagement. The arm also has a distal end portion configured for supporting a device with two axes of freedom for self alignment caused by gravity or weather.

### FIELD OF THE INVENTION

The present invention is directed to mounts for supporting outdoor devices off of the ground, and particularly, to device mounts with adjustable arms for positioning and orienting the device.

### BACKGROUND OF THE INVENTION

Some outdoor devices held off of the ground are conventional rain sensors such as collector-type devices that use measuring containers that collect rain. Conventional electromechanical rain sensors use hydroscopic discs that expand when water impacts the disc or use impact devices with surfaces that otherwise deform when impacted by water. In these cases, electrical signals are created that represent an amount of precipitation measured by the device. The signals are relayed to a remote controller either through wireless or wire links to the device.

It is preferred to locate certain devices such as rain sensors in a safe and open place. For example, these devices are commonly mounted relatively high on the side of a building so that it cannot be damaged by animals, people, machines, or other objects on the ground. Typically, the rain sensors have one side or face, usually the top, that must face the direction of rain to collect or sense a significant amount of a precipitation to determine a general amount of rainfall. Since the typical mount only permits the sensor to pivot up and down about a single axis and relative to a fixed arm, this requires the mount to be carefully attached to the building in a certain vertical orientation so that the sensor will be held upright to place the top of the sensor where it can intercept a sufficient amount of rain. However, if the sensor is not mounted carefully, it will not provide accurate readings. For example, when the mount is attached to the building at a slight angle (from side to side relative to an arm of the mount), the sensor will be fixed in a tilted orientation. In this situation, vertically falling rain hits an enclosed side of the rain sensor rather than the top sensing or collecting interface of the rain sensor. The sensor then may not obtain the most accurate reading from falling rain.

The known mounts also have limited adaptability and only hold the rain sensor in a fixed, typically upright, orientation. These devices, however, become less effective in a wind driven rain because the wind generally blows the rain at an angle rather than falling vertically. This effectively produces the same shortcomings as with a fixed tilted sensor. Other known mounts that hold the rain sensors in a fixed, upright orientation tend to tilt over time to non-vertical angles due to weak designs, gravity and wind. In this case, the rain sensors are fixed to tilted positions even when no wind is present. Thus, a device mount is desired that provides enhanced adaptability in positioning and orienting certain devices while also having the flexibility to mount the devices on a variety of different building surfaces and structures.

### BRIEF DESCRIPTION OF THE DRAWINGS

FIG. 1 is a front and side perspective view of an assembled device mount mounted on a gutter in accordance with aspects of the present invention;

FIG. 2 is an exploded perspective view of the device mount of FIG. 1;

FIG. 3 is a right and rear perspective view of a bracket of the device mount of FIG. 1;

FIG. 4 is a left and rear perspective view of the bracket of the device mount of FIG. 1;

FIG. 5 is a side view showing a step in the process of mounting the bracket of the device mount of FIG. 1 on a gutter;

FIG. 6 is a side view showing another step in the process of mounting the bracket of the device mount of FIG. 1 on a gutter;

FIG. 7 is a side view showing another step in the process of mounting the bracket of the device mount of FIG. 1 on a gutter;

FIG. 8 is a side view showing another step in the process of mounting the bracket of the device mount of FIG. 1 on a gutter;

FIG. 9 is a side view showing another step in the process of mounting the bracket of the device mount of FIG. 1 on a gutter;

FIG. 10 is a left-side elevational view of an arm portion of the device of FIG. 1;

FIG. 11 is a top plan view of the arm portion shown in FIG. 10;

FIG. 12 is a front end elevational view of the arm portion shown in FIG. 10;

FIG. 13 is a left-side elevational view of another arm portion of the device of FIG. 1;

FIG. 14 is a side cross-sectional view of engagement of the arm portion of FIG. 10 with the arm portion of FIG. 13;

FIG. 15 is a top plan view of the arm portion shown in FIG. 13;

FIG. 16 is an upper perspective view of a sensor engagement end of the arm portion shown in FIG. 13;

FIG. 17 is side elevational view of the device mount mounted to a generally planar structure in a tilted orientation and holding a device upright;

FIG. 18 is an upper perspective view of engagement of the arm portion of FIG. 13 with a device;

FIG. 19 is a front end elevational view of the arm portion shown in FIG. 13;

FIG. 20 is an upper and side perspective view of an alternative arm portion for another embodiment of the device mount in accordance with aspects of the present invention;

FIG. 21 is a left and bottom perspective view of another alternative arm portion with a gimbal for the device mount in accordance with aspects of the present invention;

FIG. 22 is a left and upper perspective view of the alternative arm portion of FIG. 21;

FIG. 23 is a top plan view of the alternative arm portion of FIG. 21 holding a device;

FIG. 24 is a fragmentary side view showing the gimbal of the alternative arm portion of FIG. 21 in cross-section and around a supported device supported therein; and

FIG. 25 is a side view of the device mount with the alternative arm portion of FIG. 21 and mounted on an inclined surface while supporting a device.

### DETAILED DESCRIPTION OF THE PREFERRED EMBODIMENTS

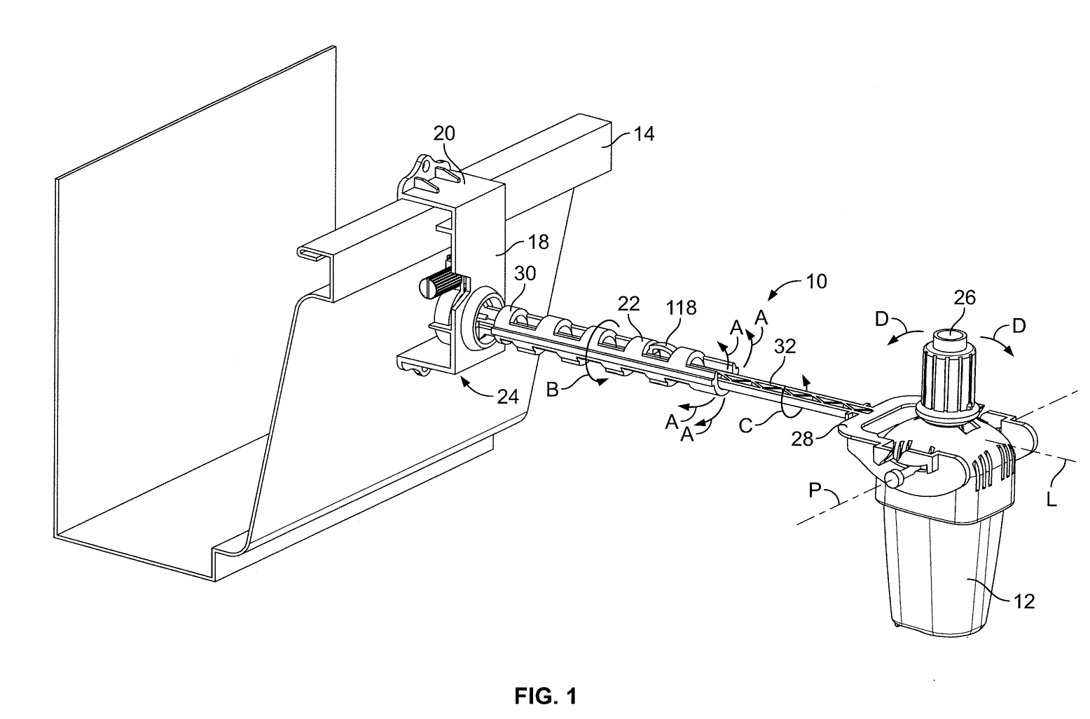

Referring to FIG. 1, a mount 10 supports a device such as a rain sensor 12. It will be appreciated, however, that the mount 10 may be used to support many other devices such as sensors detecting temperature, humidity, solar radiation and/or wind, as well as mini-weather stations, repeaters and lights.

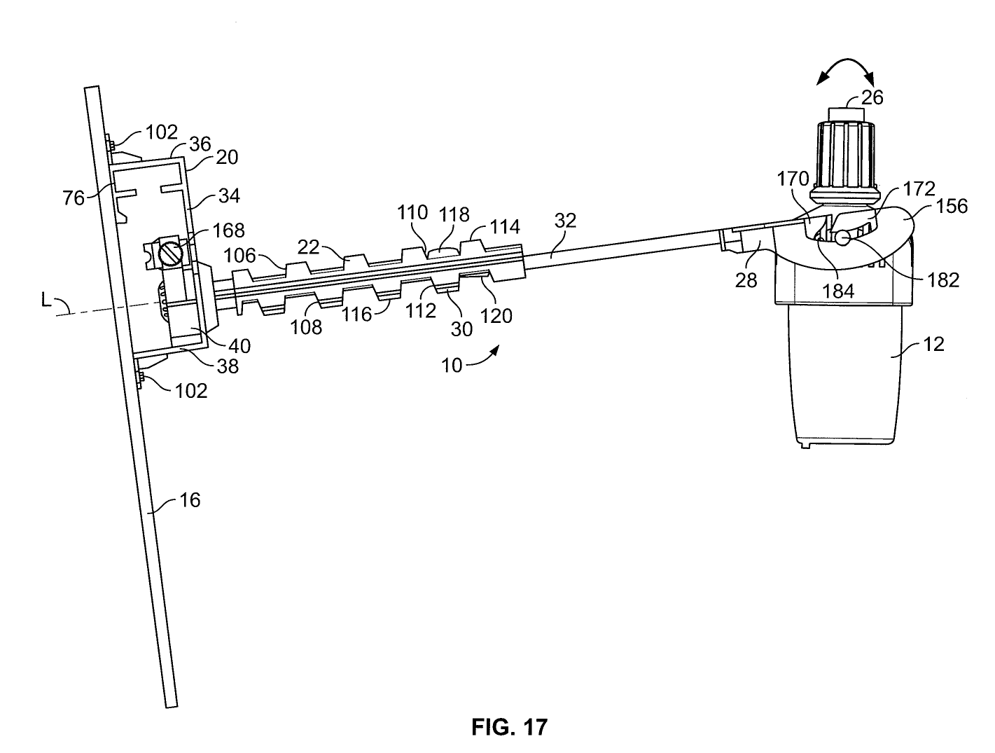

The mount 10 is shown mounted on a gutter 14, but it will be understood that the mount 10 also may be mounted on any surface including a building wall or slanted roof 16 (FIG. 17) as shown in FIG. 24 and as explained below. The mount 10 has a base 18 which, in one of many possible forms, is a bracket 20 that is secured to the gutter 14 or other surface 16 (FIG. 17). The mount 10 also has an arm 22 that is movably mounted to the bracket 20 with a releasable polyaxial engagement, such as, for example, a ball and socket joint 24. This permits the arm 22 to be tilted in many different directions relative to the bracket 20 as shown, for example, by arrows A on FIG. 1. With this type of polyaxial joint 24, the mount 10 can be mounted to surfaces with a variety of different orientations, such as horizontal, vertical, slanted, and so forth while still being able to support the rain sensor 12 in an upright orientation. The polyaxial joint 24 also permits the arm 22 to be rotated about its longitudinal axis L and within bracket 20 (as shown by arrow B) providing further adaptability.

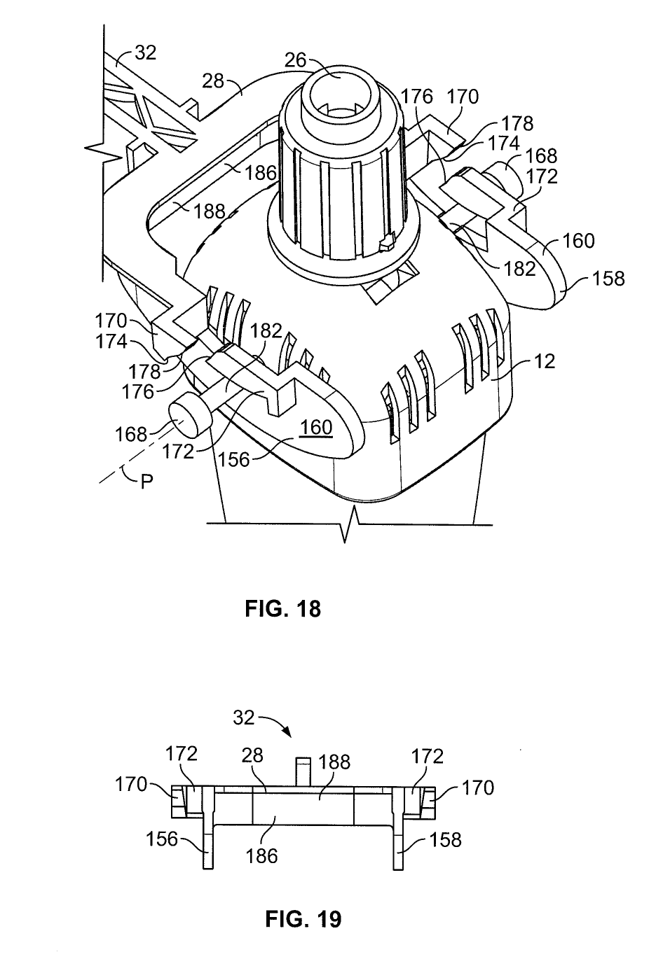

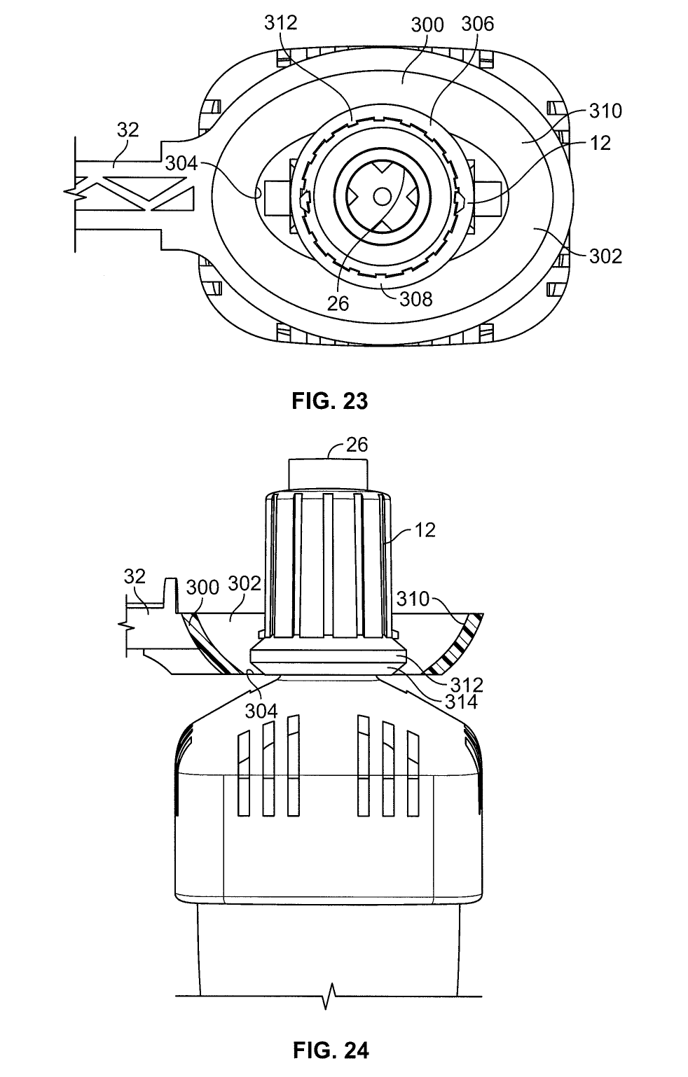

The rain sensor 12 may be a collection-type sensor but, in the illustrated embodiments, is an electronic device whether wireless or hard wired for communication with a transmitter and directly to a remote controller. The rain sensor 12 has a rain interface 26 (also shown in FIGS. 18 and 23) that collects or impacts rain in order to measure the amount of rain. In order to obtain an accurate measurement regardless of the incoming direction of the rain, the arm 22 is adaptable so that the rain sensor 12 is free to pivot while engaged to the arm 22 to orient the interface 26 to generally face toward the incoming rain, or more specifically, to maintain the interface 26 generally traverse to the direction of the rain.

Due to the polyaxial engagement between the bracket 20 and the arm 22, the arm 22 assists to provide the desired rain collecting orientation for the interface 26 regardless of the orientation of the surface the bracket 20 is mounted upon. In order to provide this adaptability of the arm 22, in addition to the polyaxial connection, the arm 22 has an adjustable length and a distal end portion 28 that is rotatable about the longitudinal axis L of the arm 22. The distal end portion 28 is configured to permit the rain sensor 12 to freely pivot about an axis P that is perpendicular to the longitudinal axis L. So configured, the rain sensor 12 is self-aligning on the device mount 10 in that it is free to pivot to stand upright due to gravity, and when rain or wind blows against the rain sensor 12, the rain sensor 12 will pivot to so that the interface 26 is directed in a direction better suited for impact by the blown rain. This permits the rain sensor 12 to self-align regardless of the orientation of the rain sensor while the rain sensor is installed on the arm.

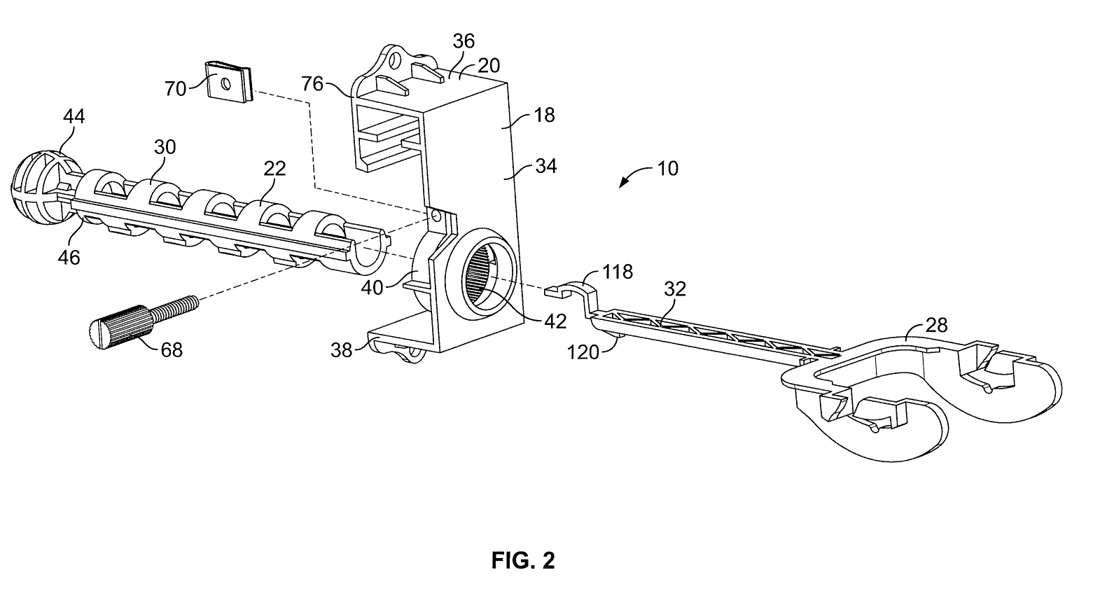

More specifically, and referring to FIGS. 2-4, the arm 22 has a first, fixed member 30 forming the polyaxial engagement with the bracket 20 and at least a second, adjustable member 32 connected to the fixed member 30 in a telescoping relation. The bracket 20 is generally C-shaped with a front plate 34 interconnecting an upper plate 36 to a lower plate 38. A cylindrical wall 40 is formed on a back side 66 of the front plate 34 and defines a socket 42 to receive a ball 44 on a proximal end portion 46 of the fixed member 30. An interior surface 48 of the cylindrical wall 40 has an array of ribs or ridges 50 extending parallel to a rotational axis R of the socket 42. The ribs 50 enhance the frictional engagement with flanges 52 that form the ball 44.

A gap 54 in the cylindrical wall 40 separates two opposite, upper portions 56 and 58 of the cylindrical wall. The upper portions 56 and 58 also are spaced rearward from the front plate 34 by extending from a lower portion 74 of the cylindrical wall 40. The upper portions 56 and 58 respectively terminate in opposing, free-ended latch-flanges 60 and 62. The latch flanges 60 and 62 have laterally accessible and concentrically aligned openings 64 (only one is shown) for receiving a locking or clamping screw 68. In the illustrated form, neither opening 64 is threaded, and a retaining nut clip 70 with a threaded bore 72 is placed on the latch flange 60 or 62 that is opposite the latch flange that engages the head of the locking screw 68. The locking screw 68 is then tightened to the retaining nut clip 70 to urge the two latch flanges 60 and 62 toward each other which then deflects the upper portions 56 and 58 of the cylindrical wall 40 toward each other to clamp the ball 44 within the socket 40. In an optional configuration, the retaining-nut clip 70 is eliminated, and at least one of the openings 64 is threaded for urging the latch-flanges 60 and 62 together.

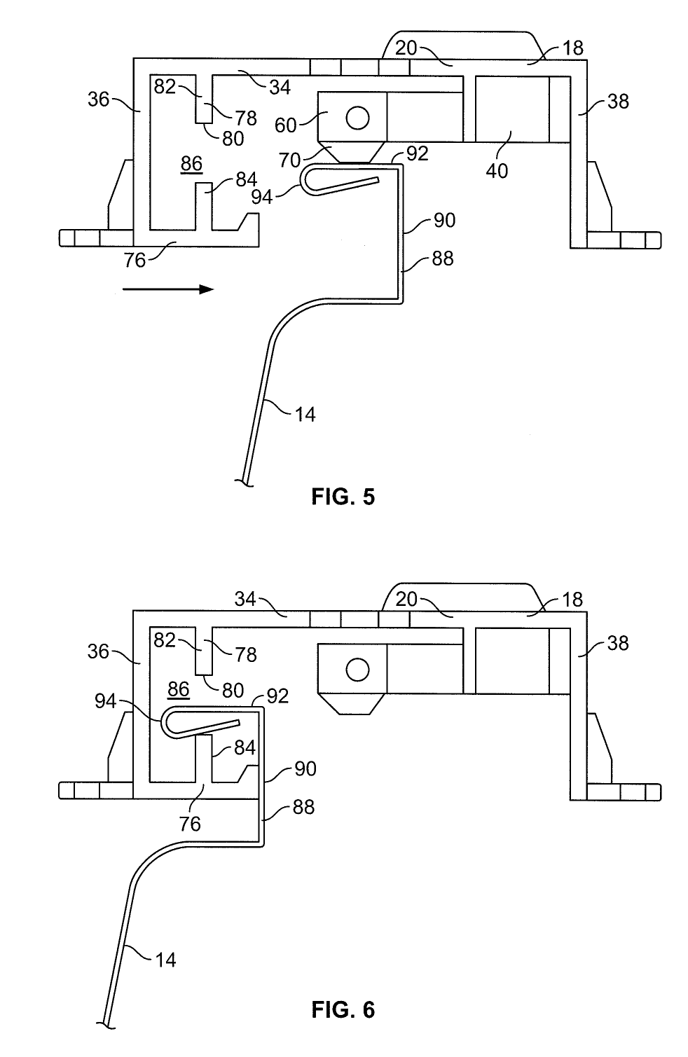

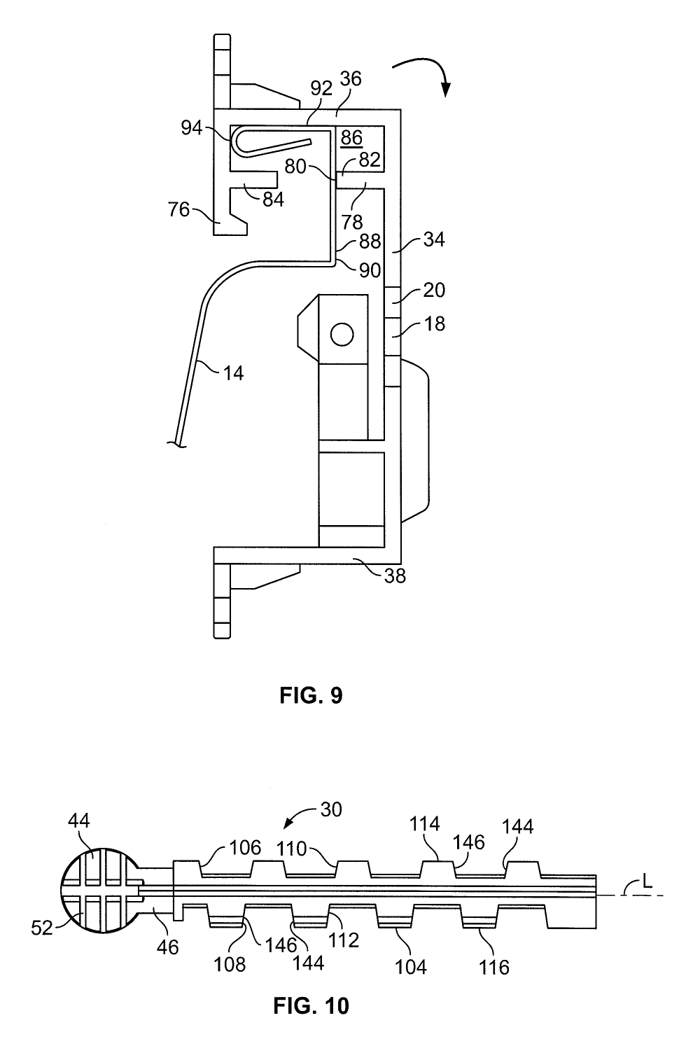

Referring to FIGS. 5-9, the bracket 20 also has a rear plate 76 extending from the upper plate 36 and parallel to the front plate 34. An interior wall 78 extends generally parallel to the upper plate 36 and in between the front plate 34 and the rear plate 76. The interior wall 78 has an opening 80 that separates a front portion 82 of the interior wall 78 from a rear portion 84 of the interior wall 78. The opening 80 provides access to the space 86 surrounded by the upper plate 36, the interior wall 78, the front plate 34 and the rear plate 76. With this configuration, the bracket 20 can be secured to a typical inverted L-shaped rim 88 of the gutter 14. The gutter rim 88 has a proximal leg 90 of the L-shape connected to a distal leg 92 of the L-shape and that has a distal end 94. In one form, the distal end 94 is rounded and formed by a folded over metal or plastic sheet.

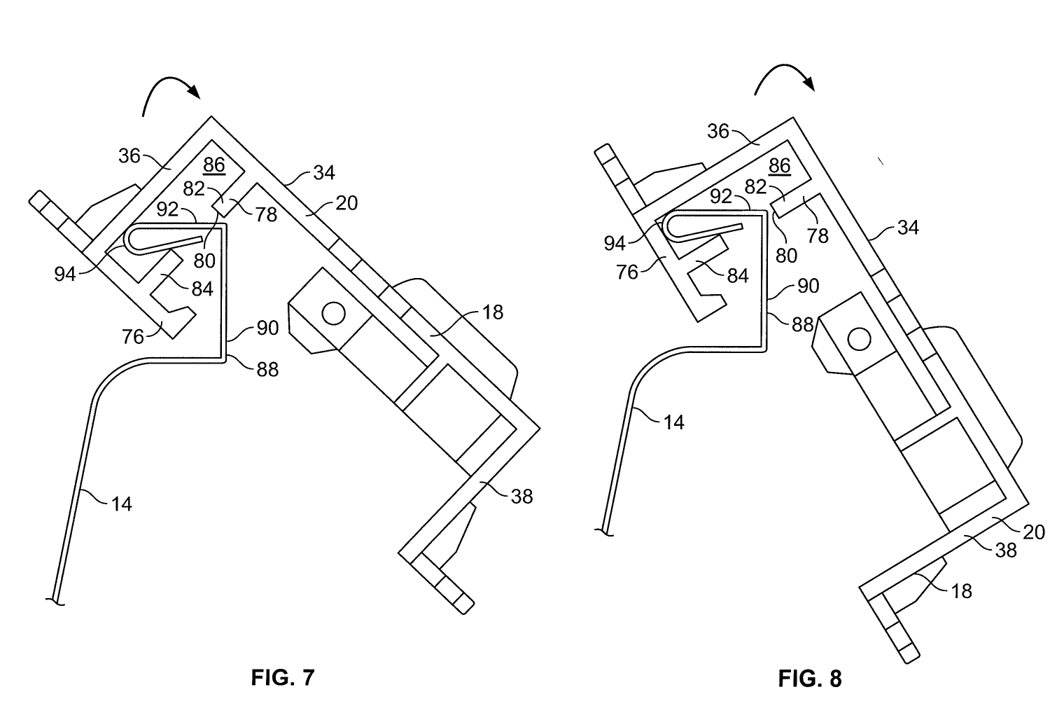

To mount the bracket 20 on the gutter rim 88, the bracket 20 is first placed on the gutter rim 88 so that the bracket reclines on the distal leg 92 of the gutter rim 88 as shown in FIG. 5. The bracket 20 is then shifted forward by shifting the upper plate 36 toward the distal end 94 of the gutter rim 86. The bracket 20 is shifted until the distal end 94 extends through the opening 80 on the interior wall 78 as shown in FIG. 6 and the proximal leg 90 of the gutter rim 88 abuts the rear plate 76 of the bracket 20. As shown in FIGS. 7-9, the bracket 20 is then rotated so that the distal end 94 abuts the rear plate 76 and the proximal leg 90 abuts the front portion 82 of the interior wall 78. The bracket 20 is sized so that the gutter rim 88 is in a tight friction fit in this configuration. The upper plate 36 engages the distal leg 92 of the gutter rim 88 to retain the gutter in the friction fit thereby securing the bracket 20 to the gutter rim 88.

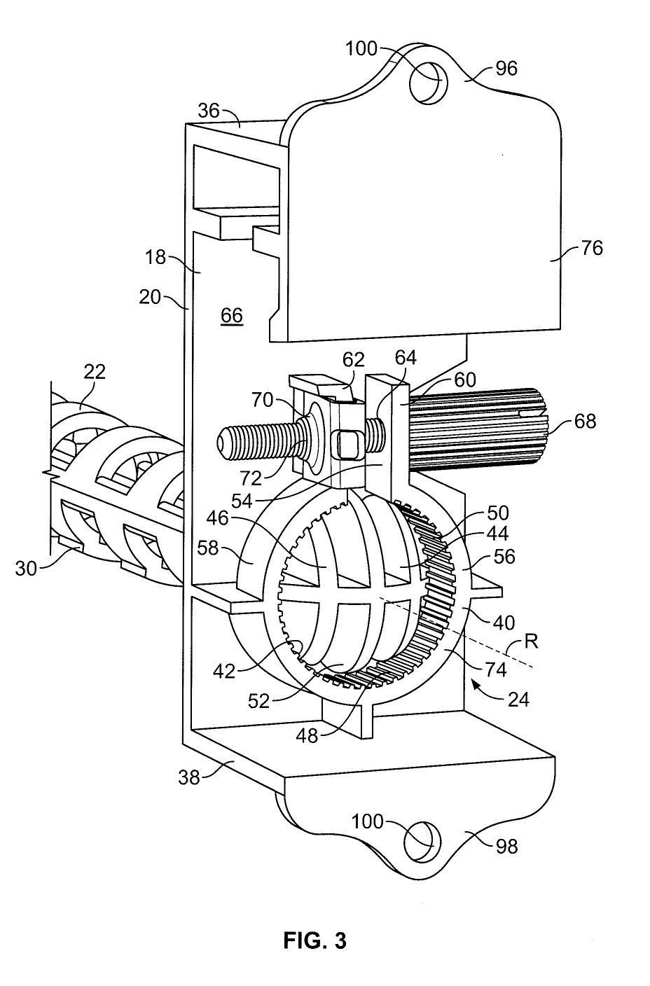

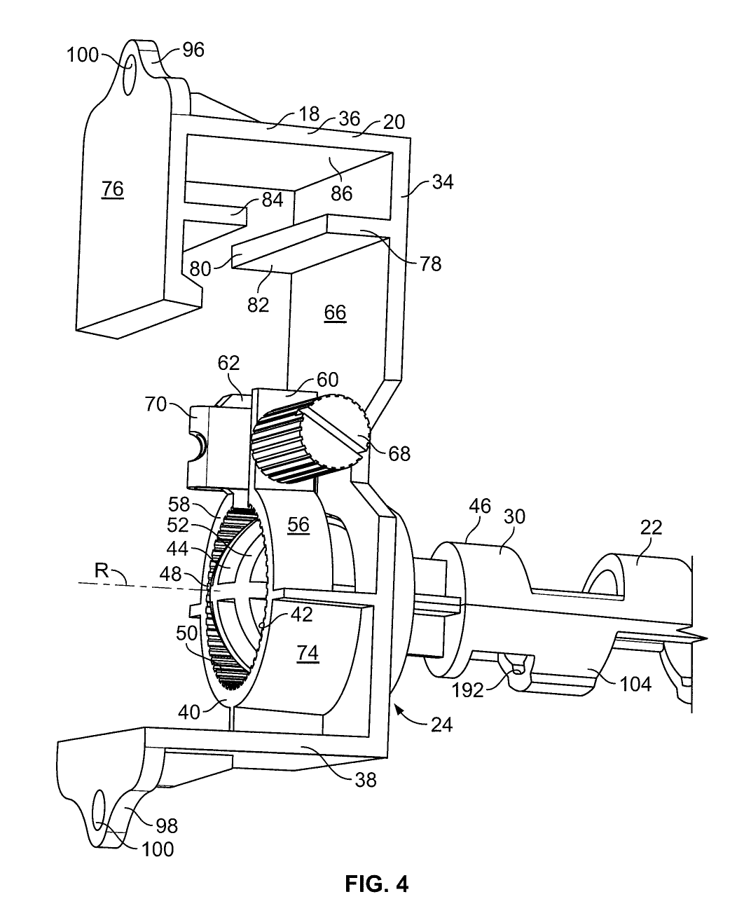

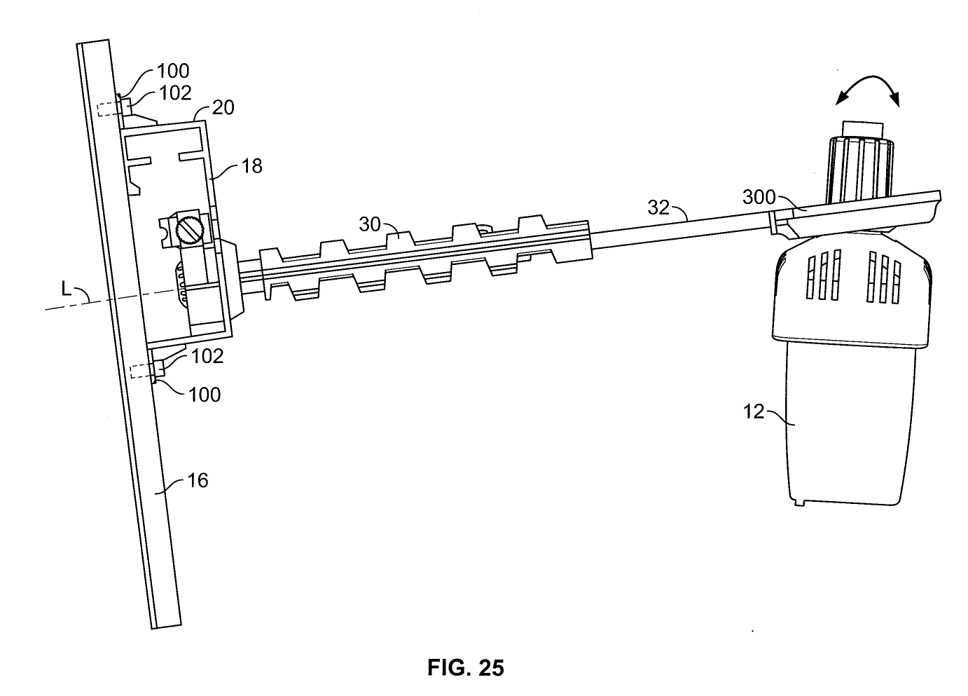

Alternatively, the bracket 20 has opposite, aligned upper and lower flanges 96 and 98 extending in opposite directions from the upper and lower plates 36 and 38 respectively, as shown in FIGS. 3-4. The flanges 96 and 98 have openings 100 to receive screws 102 for mounting the bracket 20 on the surface 16 as mentioned above and as shown on FIG. 25.

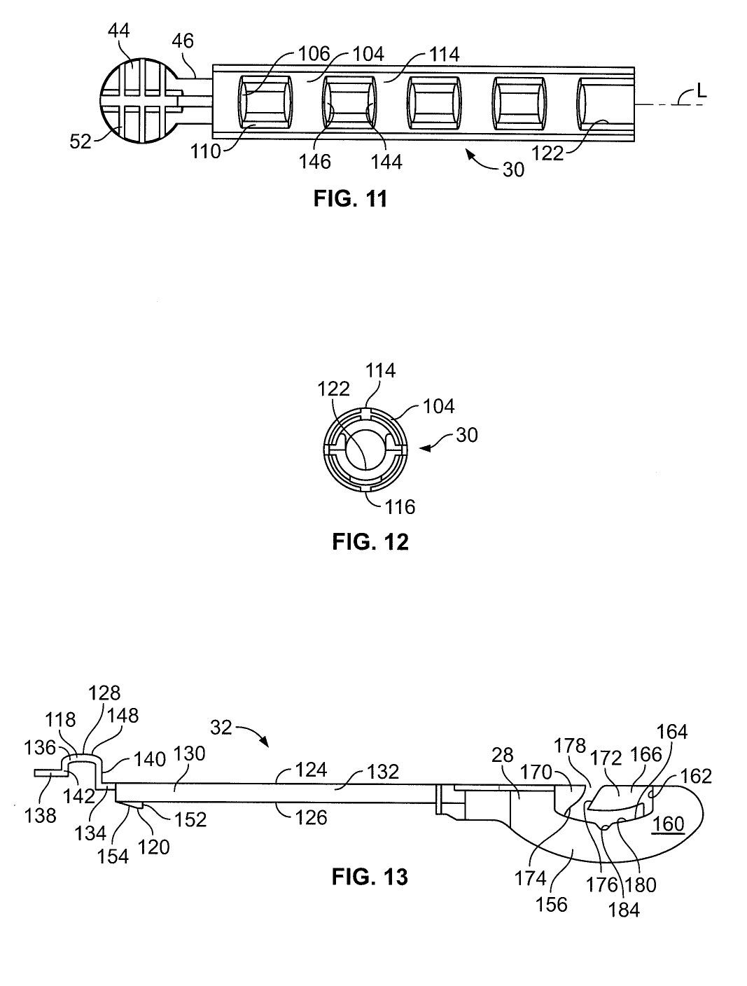

Referring to FIGS. 10-12, to provide the adjustable length and telescoping action between the fixed member 30 and the adjustable member 32 of the arm 22, the fixed member 30 has a cylindrical wall 104 with at least one array of detents spaced along the longitudinal axis L. In the illustrated form, the cylindrical wall 104 has two arrays 106 and 108 of detents 110 and 112, respectively, that are on diametrically opposite sides 114 and 116 of the cylindrical wall 104. The two arrays 106 and 108 also are alternately spaced along the longitudinal axis L, where each detent 110 or 112 may form a different axial position for the adjustable member 32 relative to the fixed member 30.

The alternating detents 110 and 112 receive corresponding, longitudinally spaced projections 118 and 120 (shown on FIG. 13) that extend from the proximal end of the adjustable member 32. The adjustable member 32 is received within an interior bore 122 formed by the cylindrical wall 104 and that opens to each of the detents 110 and 112. A lower surface 190 of the adjustable member 32 has a curvature that corresponds to the curvature of the bore 122 for smooth translation of the adjustable member 32 in the fixed member 30.

In one form, the detents 110 and 112 are generally configured the same so that both of the projections 118 and 120 can engage either detent array 106 or 108. This is provided so that the adjustable member 32 can be attached to the fixed member 30 in either of two opposite orientations (such as facing upward or downward). The fixed member 30, however, also can be rotated at bracket 20 and about longitudinal axis L to face the detents 110 and 112 toward any desired direction.

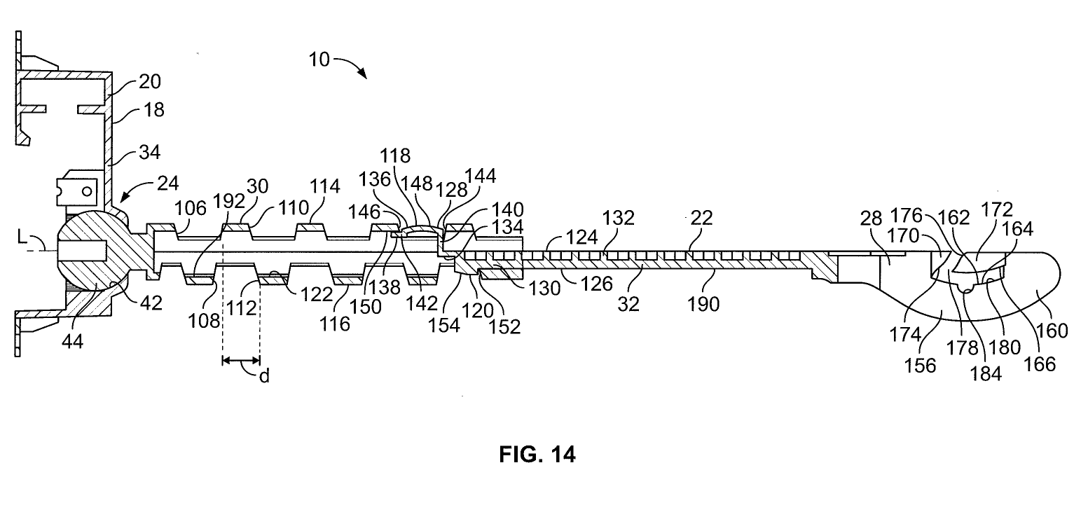

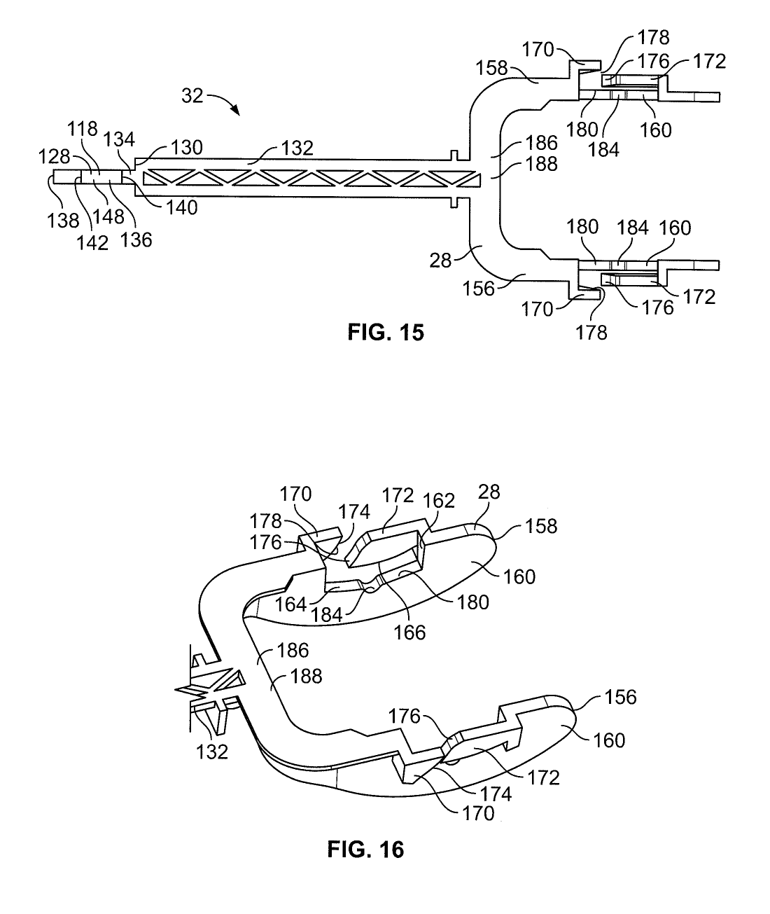

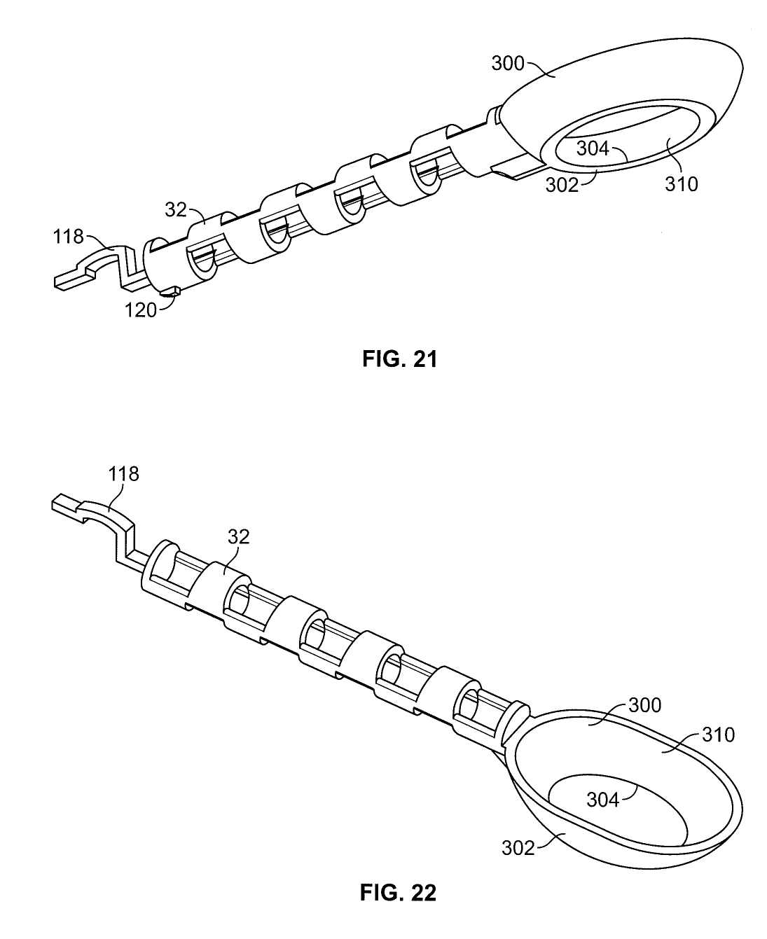

Referring to FIGS. 13-14, the first projection 118 extends laterally outward from a first side 124 of the adjustable member 32 for releasably engaging a selected one of the detents 110 on the first array 106, while the second projection 120 extends laterally outward from a second, opposite side 126 of the adjustable member 32 for releasably engaging one of the detents 112 of the second array 108. The first projection 118 may be a resilient member 128 that extends longitudinally rearward from a proximal end portion 130 of a main bar 132 forming the adjustable member 32. The main bar 132 is shown with a truss structure (FIG. 15) to reduce the amount of materials used and to eliminate problems associated with molding relatively large solid objects. For these reasons, as shown on FIGS. 21-22, a main bar also may have any other configuration such as, for example, the same detent configuration as on the fixed member 30 which may additionally be provided for aesthetic reasons or for ease of forming molds.

The resilient member 128 may be integrally formed with the main bar 132 except substantially narrower than the main bar 132 to create the resiliency of the member 128. These components as well as any of the other parts of the device mount 10 may be made of injection molded plastic except that the retaining nut clip 70 and the clamping screw 68 may be made of metal. It will be understood, however, that other materials are possible.

The resilient member 128 (also shown on FIGS. 21-22) has a longitudinal base portion 134 continuous with an outwardly and laterally bent detent-engaging or button portion 136, which, in turn, is continuous with a longitudinally extending brace portion 138. The detent-engaging portion 136 is sized to fit within or snaps into each detent 110 or 112. The detent-engaging portion 136 also has a longitudinal length that generally matches the length of each detent 110 or 112 to axially fix the projection 118 and, in turn, the adjustable member 32 to the fixed member 30. Front and rear portions 140 and 142 of the detent engaging portion 136 extend laterally to respectively oppose and/or engage a front and rear edge 144 and 146 of each detent 110 or 112 to axially fix the projection 118.

Referring to FIG. 14, the resilient member 128 is biased laterally outward toward a natural orientation. If the resilient member 128 is pressed or deflected laterally inwards or toward longitudinal axis L from the natural orientation, the resilient member 128 will shift outward once released. The bracing portion 138 is set laterally back or inward from an upper surface 148 of the detent engaging portion 136 and toward the longitudinal axis L. Thus, once the resilient member 128 is disposed within one of the detents 110 or 112, the bracing portion 138 engages an interior surface 150 of the cylindrical wall 104 to restrict further lateral outward shifting of the projection 118. In order to move the adjustable member 32 axially within the fixed member 30, the detent-engaging portion 128 may be pressed inward until its upper surface 148 clears the cylindrical wall 104. Once cleared, the adjustable member 32 is free to move axially inward until the detent-engaging portion 136 snaps into the next axially adjacent detent 110 or 112 due to the biasing force of the projection 118.

The second projection 120, in one form, extends from the opposite side of the adjustable member 32 to add further retention strength against unintentional pull-out of the adjustable member 32 from the fixed member 30. Thus, in one possible form, the fixed member 30 is a generally triangular fin with a lateral retaining side 152 facing distally or away from the bracket 20. The retaining side 152 is positioned to engage the front edges 144 of the detents 110 or 112 to restrict further longitudinal motion of the adjustable member 32 distally and out of the fixed member 30. To pull the adjustable member 32 axially and distally relative to the fixed member 30, the adjustable member 32 is pressed slightly inward to clear the cylindrical wall 104. In one form, the cylindrical wall 104 between the detents 112 may be thinner at its bottom side 116 or may have grooves 192 as shown in FIG. 4 or other shapes to deepen the bore 122. This will provide the projection 120 with a shorter distance to be pressed inward to clear the cylindrical wall 104 to move the adjustable member 32 distally.

The projection 120 also has a laterally and outwardly sloped camming side 154 opposite the retaining side and facing proximally or toward the bracket 20 for engaging against the rear edges 146 of the detents 110 or 112. This shifts the projection 120 laterally inward to clear each detent 110 or 112 as the adjustable member 32 is moved longitudinally into the fixed member 30.

The second projection 120 also extends from at or near the proximal end portion 130 but distally from the detent-engaging portion 138 a longitudinal distance that generally matches the longitudinal distance d (shown on FIG. 14) from a front edge 144 of each detent on one of the sides 114 or 116 of the fixed member 30 to a front edge 144 of the next distal detent on the other side 114 or 116 of the fixed member 30 and vice versa. Thus, both projections 118 and 120 will be locked against front edges 144 of detents 110 and 112 respectively to restrict unintentional pull-out. So configured, the adjustable member 32 can be axially telescoped or translated relative to the fixed member 30 so that the projection 118 selectively engages one of the detents 110 or 112 to set the arm 22 at a desired length.

Even while the adjustable member 32 is axially fixed to the fixed member 30 by the projections 118 and 120, the adjustable member 32 is still free to rotate about the longitudinal axis L (as shown by arrow C on FIG. 1) and within the fixed member 30. This permits the device to tilt laterally to the left or right to an upstanding orientation due to gravity or when wind or rain forces the rain sensor 12 to tilt from side to side, which in turn places the rain interface 26 on the rain sensor 12 at an orientation that is better to interface with the direction of rain. Thus, the detents 110 and 112 extend circumferentially on the cylindrical wall 104 forming the fixed member 30 so that the projections 118 and 120 are free to rotate about the longitudinal axis and within the detents for a predetermined angle. In one form, the projections 118 and 120, and in turn the adjustable member 32 and rain sensor 12 mounted thereon, are free to tilt laterally through a range of up to at least approximately 90 degrees. It will be understood that the circumferential or arc length about axis L of the detents may be changed to provide other ranges for freedom to rotate the adjustable member 32.

Referring to FIG. 1, to further permit the rain sensor 12 to self-align, the distal end portion 28 of the arm 22 rotatably receives the rain sensor 12 so that the device is free to pivot forward and rearward (as shown by arrows D) and about an axis P transverse to the longitudinal axis L to align its interface 26 generally transverse to the direction of rain and more into the direction of the rain.

Referring again to FIGS. 13-19, in one form, the distal end portion 28 includes prongs 156 and 158 that respectively extend on left and right sides of the rain sensor 12 so that the device is free to hang and pivot between the prongs 156 and 158. In the illustrated embodiment, the prongs 156 and 158 extend integrally from opposite ends of a common, laterally extending support member 186 at a distal end 188 of the adjustable member 32. The prongs 156 and 158 extend parallel to each other and are mirror images of each other so that they have the same symmetrical components. Thus, only one needs to be described in detail.

For prong 156, a wall 160 has an indent 162 that forms a slot 164 as viewed from the side (FIG. 13). An upper side 166 of the slot 164 is formed by first and second retainer walls 170 and 172 that extend laterally outward from the wall 160. The retainer walls 170 and 172 bend to extend parallel to and spaced from the wall 160 and toward each other. Opposing diagonal camming surfaces 174 and 176 respectively on the first and second retainer walls 170 and 172 define a gap 178 therebetween and may be contoured to guide the pin 182 to the slot 164. The surfaces 174 and 176 taper rearwardly as the surfaces 174 and 176 extend toward a bottom surface 180 of the indent 162 that forms the bottom of the slot 164. The gap 178 provides access to the slot 164 for a pin 182 extending laterally from the rain sensor 12, and the diagonal surfaces 174 and 176 are provided so that it is difficult to unintentionally disengage the pin 182 from the slot 164. The pin 182 may have a widened head 168 to retain the pin laterally (from side to side) in the slot 164.

To place the pin 182 in the slot 164, the pin 182 is placed through the gap 178 and onto the bottom surface 180. The bottom surface 180 has a further indent or groove 184 to hold and rotatably receive the pin 182 so that the rain sensor 12 can rotate as shown in FIG. 17. The bottom surface 180 also may be concavely arcuate with the groove 184 at a lowest-most point of the bottom surface 180 so that the weight of the rain sensor 12 can pull the pin 182 back into the groove 184 when wind, rain or other objects dislodge the pin 182 from the groove 184.

It will be understood that the device mount 10 and rain sensor 12 may provide one or more slot and pin connections for rotatably holding the rain sensor 12. In the illustrated embodiment, the rain sensor 12 has two oppositely extending pins 182 that engage the corresponding slots 164 on the prongs 156 and 158. Since the pins 182 are fixed to the rain sensor 12, it can be difficult to align and mount the pins in the slots 164. Thus, the slots 164 have a length sufficient to provide some play or clearance for permitting the pins 182 to be angled relative to the longitudinal axis L (other than only perpendicular) in order to move the pins 182 through the gaps 178 and place the pins 182 into the grooves 184 in the slots 164. Similarly, the retaining walls 170 and 172 are laterally spaced different distances from the wall 160 so that the pins 182 may be angled vertically to provide further play while one of the pins 182 extends through the gap 178.

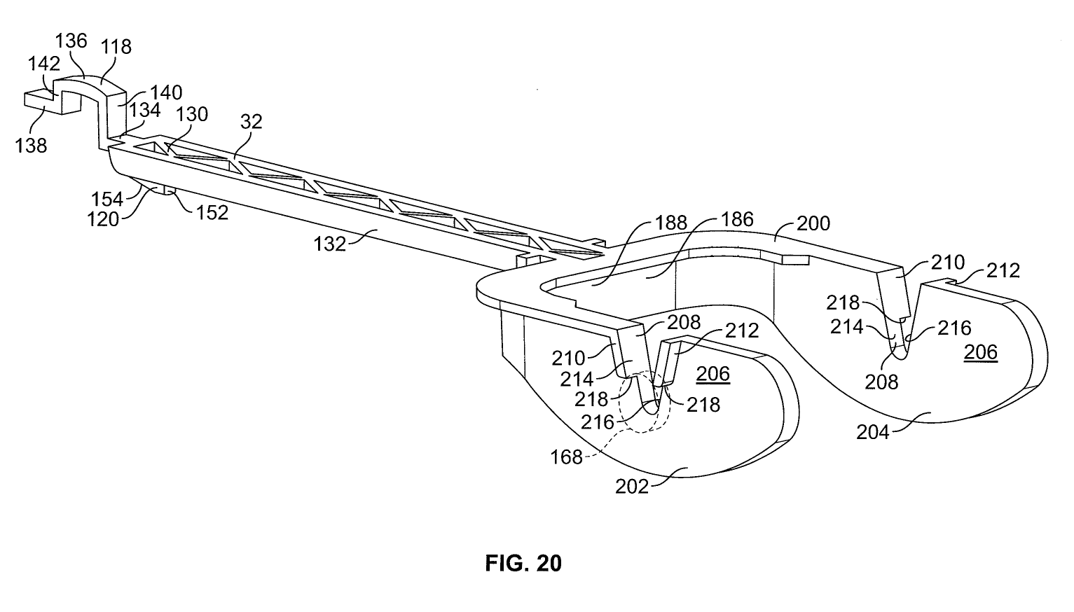

Referring to FIG. 20, for an optional configuration of a distal end portion 200 for the arm 22 and adjustable member 32, a prong 202, and similarly an opposite symmetrical prong 204, has a wall 206 with a V-shaped groove 208 for receiving the pin 182 extending from the rain sensor 12. The prong 202 has a retaining portion including one or more laterally and outwardly extending flanges 210 and 212 on opposite sides 214 and 216 of the groove 208. When assembled, a bottom surface 218 and 220 of each flange 210 and 212 releasably engages the widened head 168 of the pin 182 so that the pin 182 is secured within the groove 208. In order to disengage the pin 182 from the groove 208, the prongs 202 and 204 are pressed toward each other until the flanges 210 and 212 are moved laterally from over the head 168 of the pins 182. Once removed, the head 168 has clearance to be removed from the groove 208.

Referring to FIGS. 21-25, for yet another optional embodiment, an alternative distal end portion 300 of the arm 22 and adjustable member 32 has a gimbal 302 for pivotally supporting the rain sensor 12 in a polyaxial engagement that permits the device to tilt in any horizontal direction relative to longitudinal axis L. The gimbal 302 is annular or generally oval shaped and has a central opening 304 for receiving the rain sensor 12. The gimbal 302 also has an arcuate indent, and more specifically, a generally bowl shaped interior surface 306 that engages at least two opposite sides 308 and 310 of an annular flange or lip 312 extending radially outward from the rain sensor 12. An underside 314 of the lip 312 is generally convex or slanted as shown in FIG. 24 to facilitate pivoting of the lip 312 on the arcuate indent or interior surface 306. Otherwise, all of the other features for this embodiment are the same or similar as discussed above for the other embodiments.

Referring to FIG. 1, with the distal end portion 28 permitting the rain sensor 12 to pivot from front to back (or the distal end portion 300 permitting pivoting in all horizontal directions), and the engagement between the fixed member 30 and the adjustable member 32 permitting the rain sensor 12 to pivot from side to side, the rain sensor 12 is free to pivot in any direction except that the arm 22 and the detents 110 and 112 block rotation of the rain sensor 12 so that, in the illustrated form, the device cannot pivot to an inverted orientation which could dislodge the device from the distal end portions 28, 200, or 300 and orient the interface 26 facing away from rain. It will be understood, however, that the rain sensor 12 could be permitted to rotate in any direction for 360 degrees by modifying arm 22 to provide clearance for the rain sensor 12 to rotate 360 degrees about its pins 182 and modifying the length of the detents 110 and 112 so that the adjustable member 32 can rotate approximately 360 degrees on the fixed member 30.

While the invention has been described with respect to specific examples including presently preferred modes of carrying out the invention, those skilled in the art will appreciate that there are numerous variations and permutations of the above described systems and techniques that fall within the scope of the invention as set forth in the appended claims.

1. A device mount to support a device, comprising:
a base; and
an arm supported by the base, the arm engaging the base with a polyaxial engagement, and the arm having a distal end portion configured for supporting a device with two axes of freedom for self alignment caused by gravity or weather.

2. The device mount of claim 1 wherein the polyaxial engagement comprises a ball and socket joint.

3. The device mount of claim 1 wherein the base is configured to mount to a flat structural surface and a gutter rim.

4. The device mount of claim 1 wherein the base is a bracket defining openings for receiving fasteners to mount the bracket to a generally planar structural surface, and having two spaced walls defining a space therebetween for receiving a gutter rim with a friction fit to mount the bracket to the gutter rim.

5. The device mount of claim 1 wherein the arm has an adjustable length.

6. The device mount of claim 1 wherein the arm comprises a first member and a second member having a telescoping relation to the first member for adjusting the length of the arm.

7. The device mount of claim 6 wherein the arm defines a longitudinal axis, and the first member defines an array of detents spaced along the axis, and the second member comprises at least one projection for selectively engaging one of the detents for axially fixing the second member relative to the first member.

8. The device mount of claim 7 wherein the detents extend circumferentially around at least a portion of the first member and about the longitudinal axis to permit the at least one projection to rotate about the longitudinal axis for permitting the second member to rotate relative to the first member.

9. The device mount of claim 1 wherein the device is a rain sensor that has a rain interface, and the arm has a distal portion configured to rotatably receive the device so that the device is free to pivot generally transverse to the direction of rain.

10. The device mount of claim 9 wherein the distal portion defines at least one slot to receive a pin of a device.

11. The device mount of claim 10 wherein the distal portion defines at least two slots that are each capable of receiving a pin on a device.

12. The device mount of claim 11 wherein the distal portion has a plurality of prongs that are capable of supporting a device therebetween.

13. The device mount of claim 12 wherein at least one of the plurality of prongs includes a retaining portion for releasably engaging at least one pin of a device so that shifting of at least one of the plurality of prongs to disengage the retaining portion from a pin of a device provides clearance for disengagement.

14. The device mount of claim 9 wherein the distal portion defines an arcuate indent capable of receiving a convex portion of a device for forming a polyaxial engagement.

15. The device mount of claim 9 wherein the distal portion has a gimbal capable of pivotally supporting a device.

16. The device mount of claim 1 wherein the base is configured to mount to a generally L-shaped gutter rim having a proximal leg and a distal leg with a distal end, the base comprising:
at least two spaced wall portions comprising a first wall portion engaging the distal end and a second wall portion engaging the proximal leg so that the gutter rim is held in a friction fit therebetween.

17. The device mount of claim 16 wherein the base further comprises a third wall portion generally extending between the first and second wall portions for engaging the distal leg to retain the distal leg in the friction fit.

18. The device mount of claim 1 wherein the arm is configured so that he device self-aligns regardless of the orientation of the device while the device is installed on the arm.

19. A rain sensor mount for supporting a device with an interface for receiving rain, comprising:
a base; and
an arm movably mounted to the base and being adaptable so that the device mount may be alternatively mounted on surfaces with a variety of orientations while supporting the device so that the device is free to automatically shift the interface to generally face toward rain.

20. A rain sensor mount, comprising:
a base; and
an arm mounted on the base, and having at least first and second members engaged in telescoping relation and generally defining a longitudinal axis, the first member having a longitudinally spaced array of detents, the second member having a projection for selectively and releasably engaging one of the detents to axially fix the second member to the first member, each detent extending circumferentially relative to the longitudinal axis to permit the second member to rotate about the longitudinal axis.

21. A rain sensor mount for supporting a rain sensor having a rain collecting orientation, comprising:
a base; and
an arm having a proximal portion movably mounted on the base and a distal portion connected to the proximal portion and movably engaging the device so that the device is free to pivot on the distal portion to a rain collecting orientation.

22. A base of a rain sensor mount for supporting a rain sensor on a generally L-shaped gutter rim having a proximal leg and a distal leg with a distal end, the base comprising:
at least two spaced wall portions comprising a first wall portion engaging the distal end and a second wall portion engaging the proximal leg so that the gutter rim is held in a friction fit therebetween.

23. The base of claim 22 further comprising a third wail portion generally extending between the first and second wall portions for engaging the distal leg to retain the distal leg in the friction fit.
